(19) United States
(12) Patent Application Publication
(10) Pub. No.: US 2024/0393186 A1
(43) Pub. Date: Nov. 28, 2024

(54) LINEAR RATIOMETRIC METAL RESISTOR-BASED TEMPERATURE SENSOR WITH REMOTE SENSING SUPPORT

(71) Applicant: Intel Corporation, Santa Clara, CA (US)

(72) Inventors: David E. Duarte, Portland, OR (US); Ayan Kar, Portland, OR (US); Sameer Jayanta Joglekar, Beaverton, OR (US); You Li, Hillsboro, OR (US); James S. Ayers, Portland, OR (US)

(21) Appl. No.: 18/324,578

(22) Filed: May 26, 2023

(51) Int. Cl. G01K 7/22; H01C 7/00

(52) U.S. Cl. CPC G01K 7/22; H01C 7/006; H01C 7/008

(57) ABSTRACT

Embodiments herein relate to a temperature-sensing circuit for a semiconductor device. The circuit has a remote temperature-sensing element (RTSE) including a metal thermistor formed in a metal layer on the front side or backside of a substrate. The metal thermistor may be serpentine or spiral shaped. The RTSE communicates with a separate sense circuit at another location such as on the substrate. The RTSE can further include a thin film resistor (TFR) in an adjacent dielectric layer of the stack or within the sense circuit. The RTSE is driven alternately at opposing ends to cancel out the effects of power supply variations. An output voltage which represents a sensed temperature is obtained from a point between the metal thermistor and the TFR for processing by an analog-to-digital converter.

### FIELD

The present application generally relates to the field of computing devices and, more particularly, to temperatures sensors in computing devices.

### BACKGROUND

Computing devices such as desktop personal computers (PCs) and laptop computer or other mobile devices include many power-consuming components. These components include a central processing unit (CPU) or other processor, other internal integrated circuits and memory circuits. These components become hot as they operate. Accordingly, temperature sensors can be used in computing devices to monitor the temperature and make adjustments such as reducing a clock speed if the temperature exceeds a limit. This helps optimize performance and reliability. However, various challenges remain in obtaining an accurate measurement of temperature at a location of interest in the computing device.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 depicts a cross-sectional view of an example semiconductor device 100 including a remote temperature-sensing element (RTSE) 102 in a transistor layer 104 of a substrate 106.

FIG. 2 depicts a cross-sectional view of an example semiconductor device 200 including a metal thermistor 202 in a selected metal layer M5 in a front side stack 204 of a substrate 206, and a sense circuit 220 including a thin film resistor (TFR) 216, according to various embodiments.

FIG. 3 depicts a cross-sectional view of an example semiconductor device 300 including the metal thermistor 202 of FIG. 2 and a thin film resistor (TFR) 306 in an adjacent dielectric layer D5, according to various embodiments.

FIG. 4 depicts a cross-sectional view of an example semiconductor device 400 including a remote temperature-sensing element 415 in a backside stack 412 of substrates 406 and 408, according to various embodiments.

FIG. 5A depicts an example bridge circuit 500 including first and second branches 510 and 520, respectively, which each include a metal resistor and a thin film resistor, according to various embodiments.

FIG. 5B depicts an equation for Vleft in the bridge circuit of FIG. 5A, according to various embodiments.

FIG. 5C depicts an equation for Vright in the bridge circuit of FIG. 5A, according to various embodiments.

FIG. 5D depicts a transfer function for a code of an analog-to-digital converter (ADC), according to various embodiments.

FIG. 5E depicts an equation which expresses the transfer function of FIG. 5D in terms of temperature, according to various embodiments.

FIG. 5F depicts an equation which is an approximation of the equation of FIG. 5E, according to various embodiments.

FIG. 6 depicts a top view of an example metal thermistor 802 and the thin film resistor 1000 of FIG. 10 in a non-overlapping configuration, according to various embodiments.

FIG. 7 depicts a top view of an example metal thermistor 702 and the thin film resistor 1000 of FIG. 10 in an overlapping configuration, according to various embodiments.

FIG. 8 depicts a top view of a metal thermistor 802 having a serpentine shape, as an example implementation of the metal thermistor 202 of FIG. 2, according to various embodiments.

FIG. 9 depicts a top view of a metal thermistor 902 having a spiral shape, as an example implementation of the metal thermistor 202 of FIG. 2, according to various embodiments.

FIG. 10 depicts a perspective view of a thin film resistor 1000 and contacts 1004 and 1006 in the dielectric layer D5 of FIG. 3, according to various embodiments.

FIG. 11 depicts an example circuit 1100 including a remote temperature-sensing element (RTSE) 1110 and an ADC front end 1150 of a sense circuit, where the RTSE includes a metal thermistor 1112 and a thin film resistor 1114, according to various embodiments.

FIG. 12 depicts an example circuit 1200 including the remote temperature-sensing element (RTSE) 1110 of FIG. 11 and an ADC front end 1250 of a sense circuit, where the ADC front end includes built in slope trim circuitry 1252, according to various embodiments.

FIG. 13 depicts an example circuit 1300 including a remote temperature-sensing element (RTSE) 1310 and an ADC front end 1350 of a sense circuit, where the RTSE includes the metal thermistor 1112 of FIG. 11, and the ADC front end includes a thin film resistor 1351 and the built in slope trim circuitry 1252 of FIG. 12, according to various embodiments.

FIG. 14 depicts plots of the clock signals Ckph1 and Ckph2 in FIG. 11-13, according to various embodiments.

FIG. 15 depicts plots of an ADC code versus temperature for different digital codes for a typical metal thermistor (solid lines) and for a fast (lower than typical resistance) metal thermistor (dashed lines), according to various embodiments.

FIG. 16A depicts an example system 1600 which uses a temperature sensor as described herein, according to various embodiments.

FIG. 16B depicts an example control circuit 1650 for use with the system 1600 of FIG. 16A, according to various embodiments.

FIG. 17 depicts a plot of temperature error versus temperature for the system of FIG. 16A, according to various embodiments.

FIG. 18 depicts a plot of a measured equivalent code shift versus temperature for the system of FIG. 16A, at different temperatures, according to various embodiments.

FIG. 19 depicts an example circuit 1900 including multiple remote temperature-sensing element (RTSEs) and a sense circuit 1901, according to various embodiments.

FIG. 20 depicts an example plot showing a correspondence between an input voltage, Vin, and a digital code in an analog-to-digital converter (ADC), according to various embodiments.

FIG. 21 depicts an example ADC circuit 2100, according to various embodiments.

FIG. 22 illustrates an example of components that may be present in a computing system 2250 for implementing the techniques (e.g., operations, processes, methods, and methodologies) described herein, according to various embodiments.

### DETAILED DESCRIPTION

As mentioned at the outset, various challenges remain in obtaining an accurate measurement of temperature at a location of interest in a computing device, in order to optimize performance and reliability.

In particular, power management in circuits is important in enabling the highest performance possible while keeping temperatures within the limits of the cooling solution for long-term reliability. The circuits can include, e.g., central processing units (CPUs), other integrated circuits, systems-on-a-chip (SoCs), and system-in-a-package designs which include multiple integrated circuits in the same package such as in a stacked tile/chiplet design. In one possible approach, a circuit such as a Power Control Unit (PCU) can use the temperature information provided by a Digital Temperature Sensor (DTS) to ensure performance targets are met within the reliability limits. The DTS may obtain temperature data from a temperature-sensing component.

One approach to measuring temperature involves PN junction diodes or PNP bipolar junction transistors (BJTs). From a strict circuit behavior perspective, PN junction-based sensors provide a robust solution that is suitable for high volume manufacturing. In its most basic implementation, a current is passed through a diode (or a BJT), which produces a voltage (Vd or Vbe) with a strong complementary-to-absolute-temperature (CTAT) behavior. Healthy PN junctions are very stable and can withstand significant process excursions while producing consistent and repeatable behavior.

However, a limitation of diode/BJT-based sensors is that they are placed at a significant distance from a location at which the temperature is of interest (a potential hot spot). The temperature of the sensor thus varies from the temperature of the hot spot, so that the temperature of the hot spot has to be modeled, and guard bands have to be provided to ensure a margin of error.

Another issue is that manufacturing of robust PN-junctions has become more challenging in deep sub-micron technologies as processing which is targeted to improve device performance can conflict with the optimal conditions needed by the diode/BJT. Good PN junction quality can then become a variable in determining overall process cost.

The solutions described herein address the above and other issues. The solutions bridge any PN-based sensor performance gaps that could be incurred by manufacturing due to process definition cost trade-offs. The proposed designs significantly reduce the distance between the hot spot and the sensing element. This can eliminate or reduce the need for guard bands, so that the processor or other circuit can be run at a high performance level while still ensuring that temperature limits are not exceeds.

The proposed designs can work in parallel with PN-based sensors to improve thermal profile coverage.

The proposed designs can use resistor-based temperature sensors which maximize performance (sensitivity) while also considering the functional requirements of semiconductor devices such as SoCs and CPUs. The proposed designs address the fundamental limitations of on-die temperature sensing in high volume products, while ensuring that no process cost adders are incurred.

In one aspect, a temperature-sensing metal resistor, or thermistor, is created within any metal routing layer of a semiconductor device. This allows the thermistor to be placed much closer to hot spots than with previous PN-based sensor designs. A thermistor, or thermal resistor, is a resistance thermometer, or a resistor having a resistance which is dependent on temperature. The metal thermistor can be placed on a front side or backside stack of metal layers. For a front side stack, the metal thermistor is placed above hot spot. For a backside stack, the metal thermistor is placed underneath a hot spot. The metal thermistor can have a serpentine(S) or coiled/spiral shape, for example.

This approach provides the ability to reduce and possibly eliminate hot spot-to-sensor guard bands.

The designs can utilize an additional, low temperature-sensitivity resistor to enable a ratiometric architecture with a linear response, high power-supply rejection ratio (PSRR) and support for remote sensing without evident tradeoffs. Ratiometric refers to, e.g., an output signal which changes in proportion to a change in an input or supply voltage. The additional resistor may be a thin film resistor, for example. In one approach, the additional resistor is adjacent to the metal thermistor in the stack, for example, in a dielectric layer adjacent to the metal layer in which the metal thermistor is formed. In another approach, the additional resistor is remote from the metal thermistor, such as in part of a sense circuit on a substrate. A temperature coefficient of the thin film resistor may be substantially less than a temperature coefficient of the metal thermistor.

A remote sense circuit can be coupled to the metal thermistor to obtain temperature data from the thermistor in analog form and convert it to digital data for further processing by a control circuit.

The designs provided herein have a number of advantages. For example, they can use available capabilities from current and planned technology nodes, thereby avoiding or minimizing cost increases in the process development. The designs can easily integrate with an existing digital temperature sensor (DTS) back-end and provide an option for a more detailed thermal gradient coverage. The designs can be used in combination with the DTS to improve the overall thermal gradient and heat flow sensitivity and alleviate any potential PN-based sensor performance degradation when process technology decisions impact the quality of the PN junction.

The above and other advantages will be further apparent in view of the following discussion.

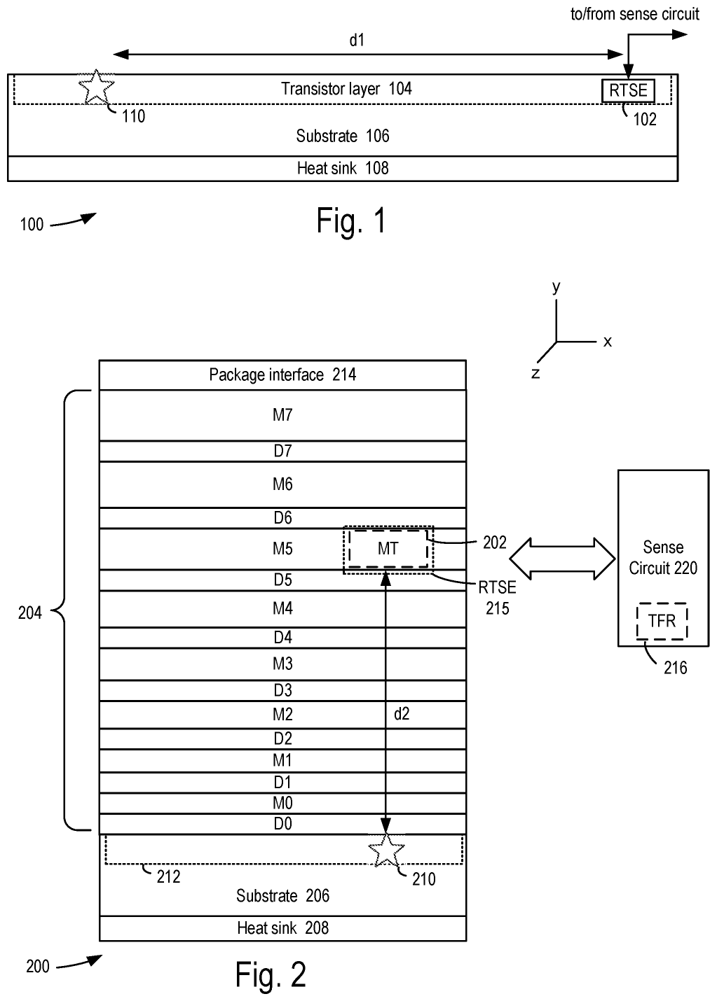

FIG. 1 depicts a cross-sectional view of an example semiconductor device 100 including a remote temperature-sensing element 102 in a transistor layer 104 of a substrate 106. The transistor layer may be a top portion of the substrate in which transistors are fabricated to create circuits such as a processor. The substrate is on a heat sink 108 such as metal which can draw heat away from the substrate. A hot spot location 110 represents a location in the transistor layer where the temperature is of interest. This may be a location which is known to become relatively hot during the operation of associated circuits. A remote temperature-sensing element (RTSE) 102 represents a temperature-sensitive component such as a PN junction diode or PNP bipolar junction transistor (BJT). The RTSE is on the transistor layer of the substrate at a distance d1 from the hot spot. Generally, temperature sensing may be performed by devices placed along the transistor layer, since this is where the heat sources (i.e., the switching transistors) are located.

The RTSE may provide temperature data to a sense circuit such as a Digital Temperature Sensor (DTS). The DTS allows for the placement of multiple RTSEs, which are much smaller than the DTS core. However, the RTSE typically cannot be placed very close to the hot spot due to the presence of other circuits. For example, even with a smaller footprint, RTSEs can only be within about d1=100-200 μm of the hot spot due to full chip and sub-block level routing and timing convergence constraints. As a result, the temperature sensed at the RTSE will be lower than that of the hot spot and a correction must be applied. To be conservative and ensure the hot spot temperature deviation from the sensed temperature is not too great, a relatively large guard band is imposed. However, guard bands that model the temperature delta between the RTSE and the hot spot are static and based on worst cases differences (for reliability), which, for most units (only a fraction of units would actually meet the worst case delta), cause the PCU to reduce time in a high performance (e.g., turbo) mode or throttle earlier, reducing the performance available to the customer and/or increasing the system cooling requirements.

FIG. 2 depicts a cross-sectional view of an example semiconductor device 200 including a metal thermistor 202 in a selected metal layer M5 in a front side stack 204 of a substrate 206, and a sense circuit 220 including a thin film resistor (TFR) 216, according to various embodiments. The substrate, which may comprise silicon, is on a heat sink 208. As before, a hot spot 210 is in a transistor layer 212 of the substrate. However, in this example, the metal thermistor 202 is located above the substrate in a front side stack 204 of alternating dielectric and metal layers. For example, dielectric layers D0-D7 and metal layers M0-M7 are depicted. The metal thermistor is a RTSE 215 in this example. The metal layers can comprise aluminum or copper, for example. The dielectric layers can comprise oxide, for example. The top of the stack is a package interface 214 such as packaging bumps (conductive solder balls).

The distance between the hot spot and the RTSE is d2, which is significantly less than d1 in FIG. 1. The distances in FIGS. 1 and 2 are not to scale. This is a relatively short distance which allows the RTSE to sense a temperature which accurately represents the temperature of the hot spot. The RTSE communicates with a sense circuit 220 to provide temperature information in the form of an output voltage. The sense circuit can be fabricated on the substrate 206, for instance, at some distance from the RTSE which is significantly greater than d2, e.g., 10-100× or more greater than d2.

A TFR in the sense circuit may be connected or coupled in series with the metal thermistor, which is a remote temperature-sensing element. Providing the TFR in the sense circuit, outside the front side stack, helps reduce the space needed by the RTSE in the stack.

The metal thermistor can be placed at any metal layer in the front side stack. The metal layers tend to be thinner further from the substrate so that a larger area may be needed to obtain a desired resistance, compared to metal layers closer to the substrate. Moreover, multiple metal thermistors can be placed at different locations in the stack to monitor multiple hot spots. The metal thermistor can be considered to be a remote temperature-sensing element (RTSE), remote from the sense circuit 220. Providing the TFR in the sense circuit reduces the space needed in the stack 204.

The sensor design achieves higher temperature sensitivity by enabling placement of metal thermistors/RTSEs closer to the hot spots, e.g., directly above the hot spots, potentially. In one approach, the RTSE and/or metal thermistor is in a front side stack, and is directly above a location in the transistor layer having a temperature of interest.

In this design, the main sensing element no longer resides along the transistor layer but is in the metal stack instead, allowing for a significant reduction of the distance between the hot spot and the RTSE, since the height of the metal thermistor in the stack is within, e.g., 10 μm, of the hot spot. This is far closer than the example of d1=100-200 μm. Also, as no transistor layer support is needed for the RTSE, the impact to the timing targets of high performance processing units are significantly reduced while potentially eliminating the need for any guard band. Additional space is made available in the transistor layer as well for other circuits.

Generally, the metal thermistor can be formed in one metal layer only, or in more than one metal layer. For example, the metal thermistor can be formed in two parts in adjacent metal layers connected by one or more vias. The resistance of the vias should be considered however, so they do not dominate the resistance of the metal thermistor.

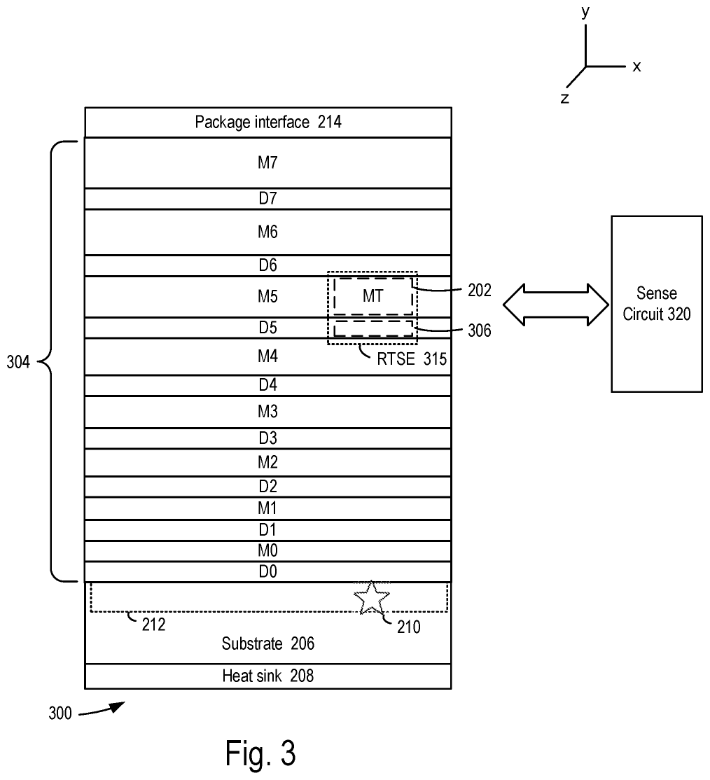

FIG. 3 depicts a cross-sectional view of an example semiconductor device 300 including the metal thermistor 202 of FIG. 2 and a thin film resistor (TFR) 306 in an adjacent selected dielectric layer D5, according to various embodiments. The TFR is connected in series with the metal thermistor in the front side stack 304 to provide an additional resistance that is relatively invariant to temperature compared to the metal thermistor. The TFR and metal thermistor together form a RTSE 315. The RTSE communicates with a sense circuit 320.

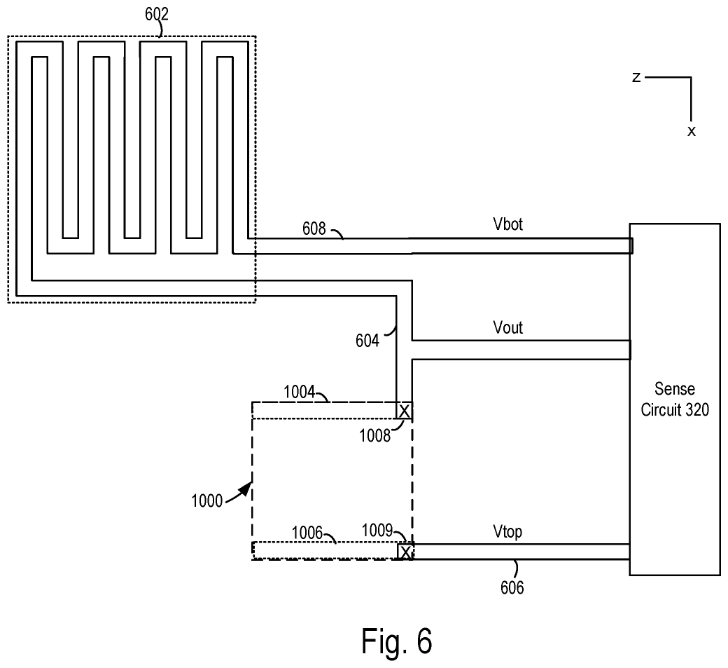

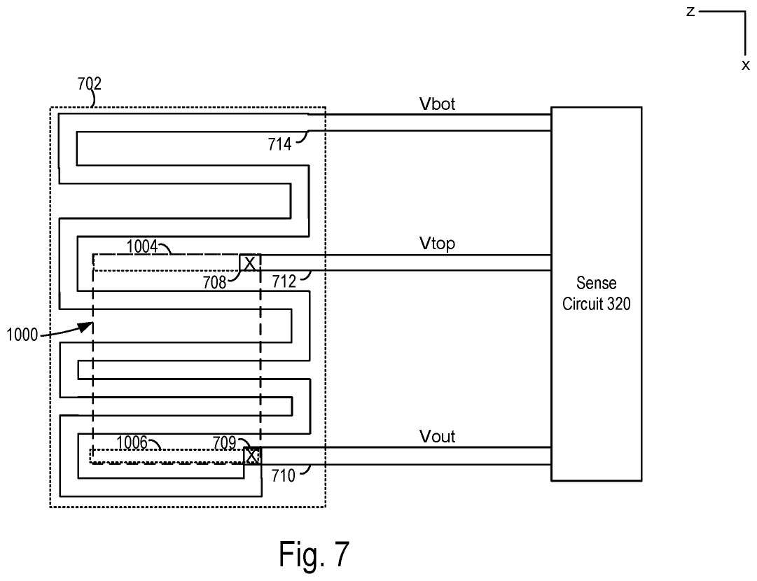

In one approach, as shown, the metal thermistor 202 overlaps with the TFR 306, when viewed from above in the x-z plane. This approach can be space-efficient. See also FIG. 7. In another approach, the metal thermistor is non-overlapping with the TFR, when viewed from above in the x-z plane. See also FIG. 6. The metal thermistor and the TFR can be coupled by vias/contacts. The size and resistance of the vias/contacts is minimized by providing the metal thermistor and TFR in adjacent layers. This avoids a significant reduction in the temperature sensitivity of the RTSE.

In another option, the TFR is in a dielectric layer adjacent to and above the metal thermistor, e.g., in D6, rather than below the metal thermistor, e.g., in D5.

The sensor design can also improve DTS coverage in products manufactured with a technology such as Intel® PowerVia, which re-purposes the backside of the wafer to support more efficient power delivery, discussed next.

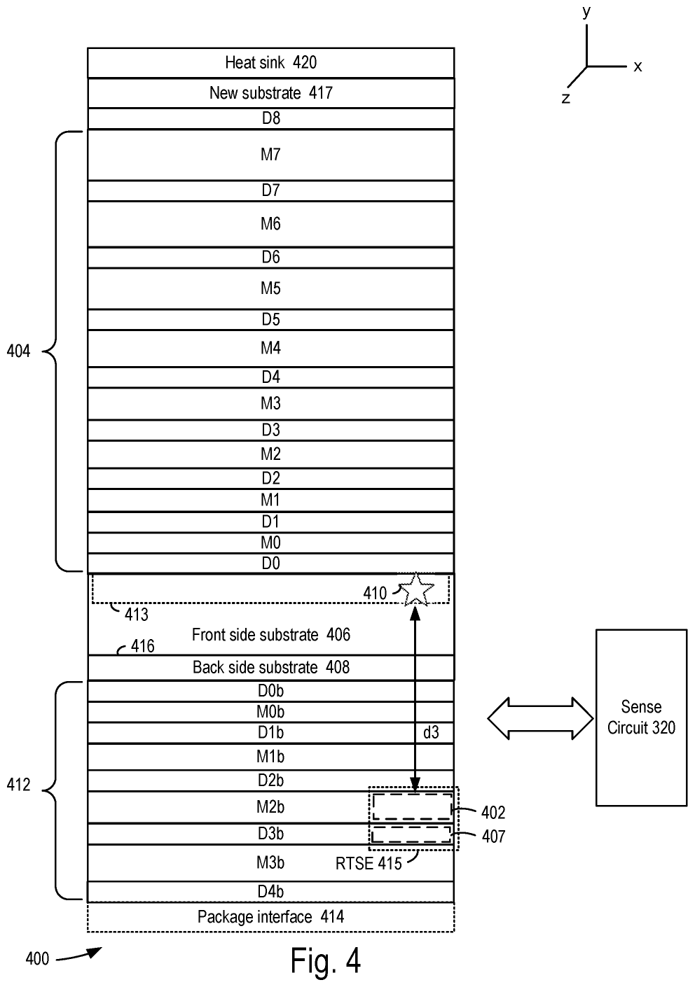

FIG. 4 depicts a cross-sectional view of an example semiconductor device 400 including a remote temperature-sensing element 415 in a backside stack 412 of substrates 406 and 408, according to various embodiments. In one approach, the front side substrate 406 with its transistor layer 413 is prepared, and the front side stack 404 is fabricated on top of the front side substrate. A new substrate 417 and heat sink 420 are provided on top of the front side stack 404. The resulting structure is then inverted. The new substrate may comprise a dielectric and is an interface to the heat sink 420.

The backside substrate 408 can be prepared separately with structures to connect circuits in the transistor layer 413 to the backside stack 412. The backside substrate 408 is then inverted and thinned, and attached to the backside 416 of the front side substrate. The backside stack includes alternating dielectric and metal layers, such as dielectric layers D0b-D4b and metal layers M0b-M3b. A package interface 414 is also provided adjacent to the bottom side stack. The resulting structure is then inverted to obtain the structure shown.

In this example, the RTSE 415 is formed in the backside stack by a metal thermistor 402 in M2b and a TFR 407 in D3b. The RTSE is at a distance d3 from the hot spot 410 in the transistor layer 413. This is a relatively short distance which allows the RTSE to sense a temperature which accurately represents the temperature of the hot spot. The RTSE communicates with the sense circuit 320. The metal thermistor can be placed at any metal layer in the front side and/or backside stack. It is possible to have metal thermistors/RTSEs on both front and backside stacks as well to sense a temperature of one or more hot spots.

In this approach, the heat sink 420 is now placed on the front side, which reverses the heat flow dynamics. The heat now needs to travel through the front side metal stack 404. The additional interface materials reduce the thermal conductivity between the hot spot and the heat sink and make it more difficult for the thermal solution to remove heat from the die. This places a higher demand on the DTS to improve its sensitivity so that the PCU can react adequately, which is precisely what the design achieves.

In one approach, the RTSE and/or metal thermistor is in a backside stack, and is directly below a location in the transistor layer having a temperature of interest.

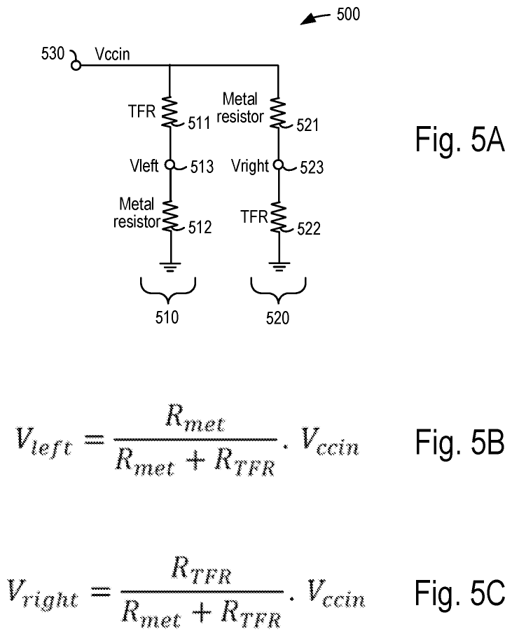

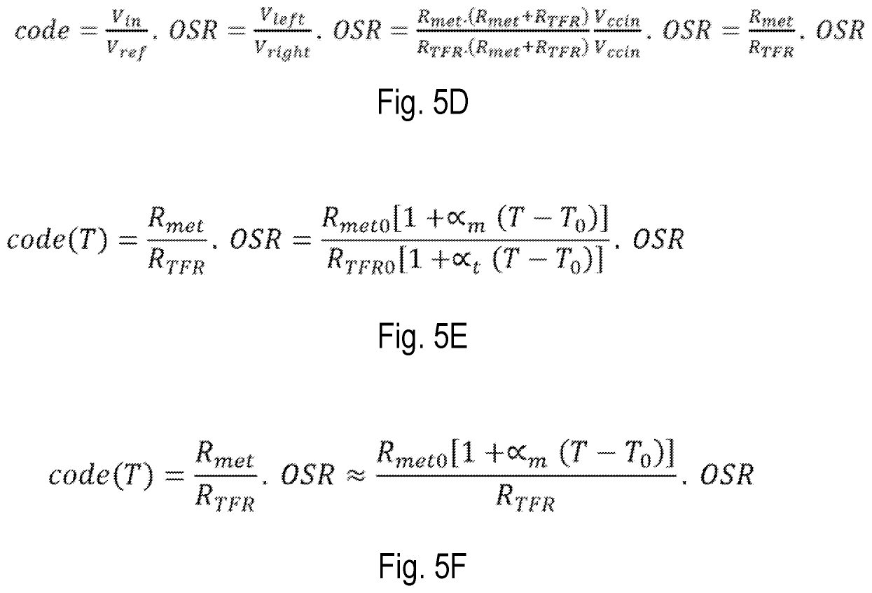

FIG. 5A depicts an example bridge circuit 500 including first and second branches 510 and 520, respectively, which each include a metal resistor and a thin film resistor, according to various embodiments. The terms metal resistor and metal thermistor are used interchangeably. An input voltage Vccin is provided at a node 530. The first, left side branch 510 includes a TFR 511 above a metal thermistor 512, where a node 513 between them has a voltage Vleft. The second, right side branch 520 includes a metal thermistor 521 above a TFR 522, where a node 523 between them has a voltage Vright. The first and second branches are grounded at their free ends.

The temperature-sensing circuit described herein may operate based on the concept of the resistor bridge structure. The bridge can be sensed by subtracting the two midpoint voltages (Vleft and Vright). To improve the sensitivity of the structure, resistors with temperature coefficients (TCs) of opposite polarities can be used in each branch. Or, to keep the concept compatible with a high-volume manufacturing process targeted to logic applications, readily available resistors can be used. In one possible implementation, a default resistor template is built using a thin film sandwiched between two metal layers to form a TFR. The metal resistor can be created by a serpentine or spiral of metal of any layer that is suitable for placement, where the layer supports bi-directional routing to and from a sense circuit.

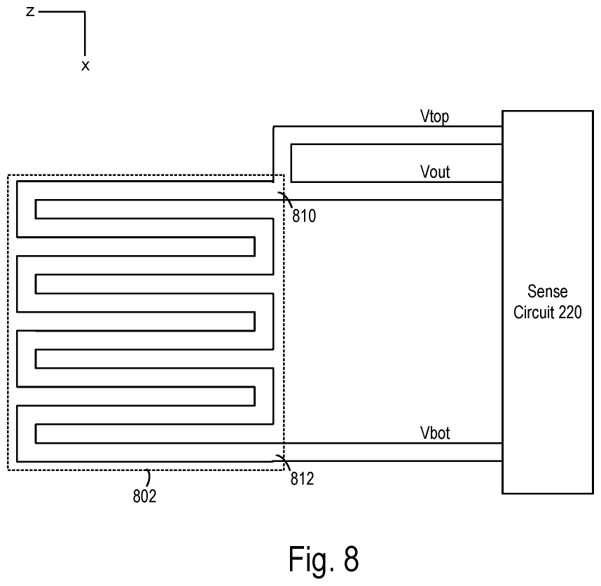

In one approach, the metal resistor and the TFR are both used and placed in series, regardless of whether the TFR is actually placed in the RTSE with the metal resistor or in the sense circuit section. FIGS. 6, 7, 11 and 12 show examples of an RTSE which includes both the metal resistor and the TFR. There is also an option in which only the metal resistor is placed in the RTSE while the TFR is kept local to the sense circuit, such as depicted in FIGS. 8, 9 and 13.

FIG. 5B depicts an equation for Vleft in the bridge circuit of FIG. 5A, according to various embodiments.

FIG. 5C depicts an equation for Vright in the bridge circuit of FIG. 5A, according to various embodiments. Vleft and Virght are expressed by the equations of FIG. 5B and 5C. respectively, as a function of Rmet, the resistance of the metal resistor, Rtfr, the resistance of the TFR, and Vccin, an input power supply voltage.

TFRs are a good choice for general-purpose analog design due to their low variability but they also have a very shallow (almost non-existent) TC. So, the bulk of the temperature sensitivity requirements fall on the metal resistors which have a resistance Rmet and which possess a high enough TC to meet the design application requirements. The temperature-sensing circuit described herein advantageously uses a potential liability (e.g., low TC resistors in temperature sensing) to achieve a number of design features.

One feature is insensitivity to a reference voltage level (e.g., Vccin). This insensitivity is achieved by using the ratio of two variables (i.e., a ratiometric design). Another feature is a linear temperature-to-code transfer function which eliminates the need for linearization logic, where the code refers to a digital code which represents the sensed temperature. Another feature is remote sensing support without the need of complex support circuitry. Another feature is a viable trim technique that can address the process targeting excursions that may impact the absolute resistance values of the metal resistor. These features are discussed in further detail below in sections A, B, C and D.

A. Regarding the Vccin insensitivity feature, by using a ratiometric scheme, the impact of Vccin on the measured voltages is minimized. Moreover, performing this operation does not require complex circuit techniques. The design may use an ADC which is already present in the computing device, for instance. One example is a digital temperature sensor which requires both an input voltage (Vin) to digitize, and a reference voltage (Vref) to compare Vin against, as expressed by the transfer function: code=(Vin/Vref)×OSR, where OSR is an oversampling rate. This also enables a fast response for the whole system (˜10 μS), which is much better than other resistor-based concepts (such as RC-based or phase-alignment loops) that require conversion times on the order of a few mS.

By using Vleft as Vin and Vright as Vref, the resulting transfer function of FIG. 5D is independent of Vccin. There is still a slight misalignment since Vin and Vref are not sampled by the ADC during the same clock phase, but this can be addressed by averaging, if needed.

FIG. 5D depicts a transfer function for a code of an analog-to-digital converter (ADC), according to various embodiments. The transfer function can be written as a function of Vccin and the resistances of the metal resistor and TFR as (Rmet/Rtfr)×OSR. The transfer function is advantageously independent of Vccin, as mentioned, so it is not affected by variations in Vccin which occur in a computing device due to noise and other reasons.

B. Regarding the linear response feature, in a strict sense, both Rmet and Rtfr have a measurable TC, so expressing the transfer function of FIG. 5D as function of temperature results in the transfer function of FIG. 5E. This transfer function is non-linear as the presence of the temperature variable in both the numerator and denominator results in a polynominal response of order higher than 1. But, since the TC of the TFR is so low, it is possible to make the approximation shown in FIG. 5F, which results in a linear response for the system. By not requiring any linearization logic, area and power are saved, and response time is reduced.

FIG. 5E depicts an equation which expresses the transfer function of FIG. 5D in terms of temperature, according to various embodiments. T represents a measured temperature, T0 denotes a reference temperature, Rmet0 denotes Rmet at T0 and Rtfr0 denotes Rtfr at T0.

FIG. 5F depicts an equation which is an approximation of the equation of FIG. 5E, according to various embodiments. In this case, the term T-T0 is present in the numerator but not the denominator, as mentioned.

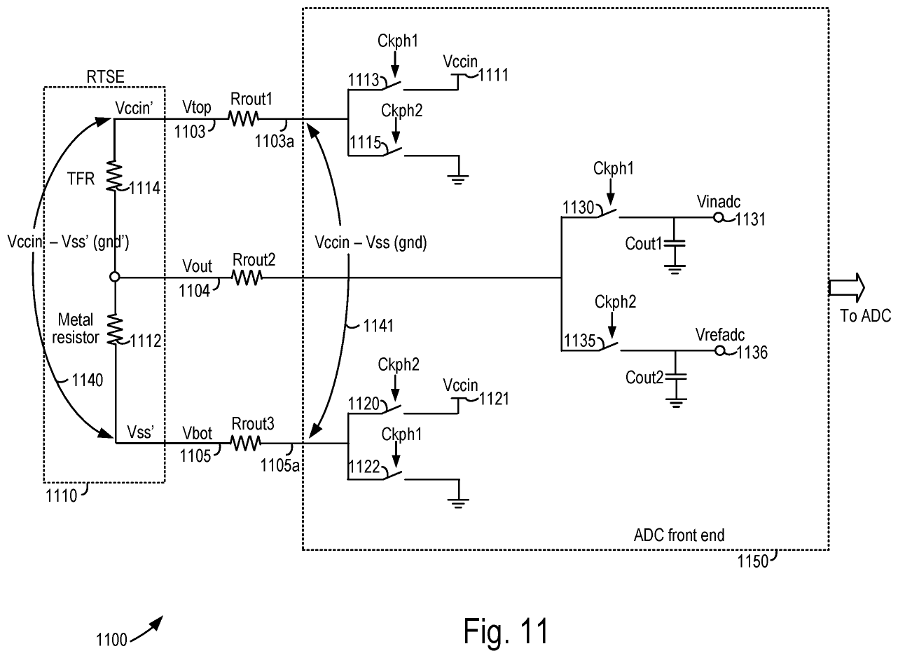

C. Regarding the remote sensing support feature, the overall sensitivity of the design is improved. This means that the bulk of the temperature sensor circuitry is placed a distance away from the RTSE to allow the RTSE to be closer to the hot spot. To improve the case of use, RTSEs should introduce the lowest possible amount of requirements from an integration point of view. To achieve this, the bridge structure (two parallel branches with the order of the resistors swapped as in FIG. 5A) can be replaced by a single resistor stack which is remotely connected to either Vccin or Vss through switches at both ends, such as depicted in FIG. 11.

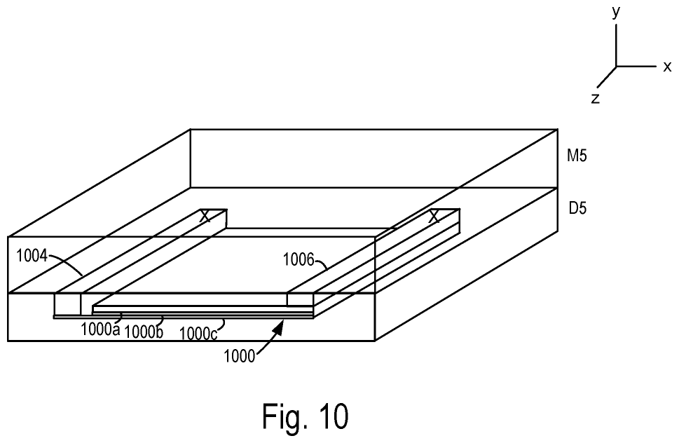

FIG. 6 depicts a top view of an example metal thermistor 602 and the thin film resistor 1000 of FIG. 10 in a non-overlapping configuration, according to various embodiments. The metal thermistor is non-overlapping the TFR in the x-z plane when viewed from above the stack. The TFR 1000 is in a dielectric layer such as D5 while the metal thermistor 602 is in the adjacent metal layer such as M5. The metal thermistor 602 is serpentine (S-shaped) as in FIG. 6. The contact 1004 of the TFR may touch a point 1008 of a path 604 of the metal thermistor, while the contact 1006 of the TFR may touch a point 1009 of a path 606 which leads to the sense circuit 320 to receive a voltage Vtop. The path 604, on one end of the metal thermistor, is electrically connected to a point 608, on another end of the metal thermistor, which in turn leads to the sense circuit to receive a voltage Vbot (Vbottom). The path 604, which is in series with and between the TFR and the metal thermistor, provides Vout to the sense circuit as an indication of temperature data.

FIG. 7 depicts a top view of an example metal thermistor 702 and the thin film resistor 1000 of FIG. 10 in an overlapping configuration, according to various embodiments. The metal thermistor is at least partially overlapping the TFR in the x-z plane when viewed from above the stack. As before, the TFR 1000 is in a dielectric layer such as D5 while the metal thermistor 702 is in the adjacent metal layer such as M5. The metal thermistor 702 is serpentine (S-shaped) as in FIG. 6. The contact 1004 of the TFR may touch a point 708 of a path 712 which leads to the sense circuit 320 to receive a voltage Vtop, while the contact 1006 of the TFR may touch a point 709 of a path 710 which leads to the sense circuit 320. The path 710, on one end of the metal thermistor, is electrically connected to a point 714, on another end of the metal thermistor, which in turn leads to the sense circuit to receive the voltage Vbot. The path 710, which is in series with and between the TFR and the metal thermistor, provides Vout to the sense circuit as an indication of temperature data.

FIG. 8 depicts a top view of a metal thermistor 802 having a serpentine shape, as an example implementation of the metal thermistor 202 of FIG. 2, according to various embodiments. The serpentine shapes allows the thermistor to have a relatively long length in a relatively compact space. The elongated shape also allows the metal thermistor to have a sufficient resistance to sense a wide range of temperatures, and facilitates connections to a sense circuit and TFR. The sense circuit 220 may alternately input voltages referred to as Vtop (travels through the TFR which is placed in series with the metal thermistor) and Vbot to opposing ends 810 and 812, respectively, of the thermistor while sensing an output voltage Vout at one end 810, to obtain temperature data. Example implementations of the sense circuit are discussed further below. The thermistor extends in the x-z plane, within a metal layer, for example.

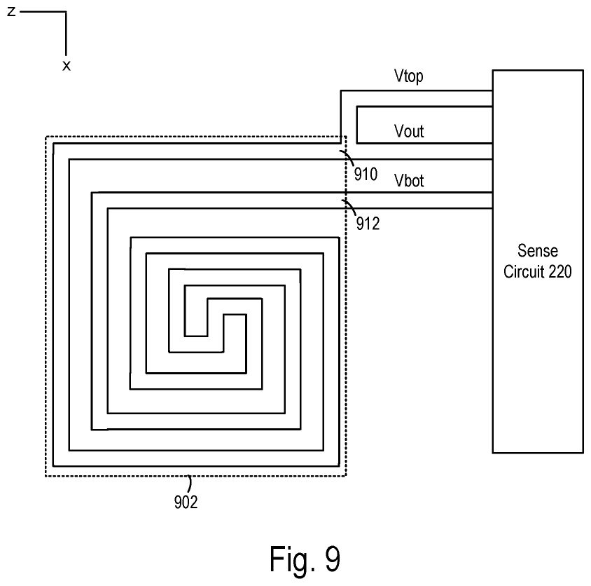

FIG. 9 depicts a top view of a metal thermistor 902 having a spiral shape, as an example implementation of the metal thermistor 202 of FIG. 2, according to various embodiments. This configuration also allows the thermistor to have a relatively long length in a relatively compact space. Other configurations are possible as well, including combinations of serpentine and spiral shapes. The sense circuit 220 may alternately input Vtop (travels through the TFR which is placed in series with the metal thermistor) and Vbot to opposing ends 910 and 912, respectively, of the thermistor while sensing an output voltage Vout at the one end 910, to obtain temperature data.

FIG. 10 depicts a perspective view of a thin film resistor 1000 and contacts 1004 and 1006 in the dielectric layer D5 of FIG. 3, according to various embodiments. In one possible approach, the TFR includes a thin dielectric film 1000b sandwiched between two metal layers 1000a and 1000c. In another approach, the TFR is built using a metal alloy, e.g., a metal nitride (for instance Tantalum nitride, TaN, or Titanium nitride, TiN). In general, any metal nitride resistor can be used that produces weak resistance changes with temperature. Contacts 1004 and 1006 are provided at opposing ends of the TFR to provide an electrical connection to the metal thermistor in the adjacent M5 layer. The contacts may comprise metal or other conductive material. The planar structure allows the TFR to be formed within the thin dielectric layer of the stack.

To fabricate the TFR, the front side stack may be formed up to the D5 layer, or other dielectric layer in which the TFR will be located. After the D5 layer is formed, a void can be formed in the layer at the location of the TFR such as by etching. One or more TFR layers can then be deposited in the void, followed by the contact material. An insulating material can then be provided above the metallic layer up to the top of the dielectric layer.

The metal layer M5 can then be deposited and patterned into the desired shape of the metal thermistor, e.g., serpentine or spiral, such as by etching the desired pattern. The metal thermistor may have the same height as the metal layer in which it is formed. Other portions of the metal layer can be used for routing signals and/or voltages to circuits on the substrate, e.g., using vias and other metal layers which are closer to the substrate. The thermistor is electrically connected to the TFR in series at contact points, such as those shown by X's in FIG. 10. Voids in the metal layer can then be filled with an insulating material before depositing the next dielectric layer, e.g., D6.

The temperature coefficient (TC) of a resistor indicates how much its value changes as its temperature changes, as well as the polarity of the change, e.g., higher or lower, and can be expressed in ppm/° C. (parts per million per degree C., where 1 ppm=0.0001%). For example, the TC can be defined as (R2−R1)/R1 (T2−T1), where R1 and R2 are first and second resistance values and T1 and T1 are first and second temperature values. A positive value of TC indicates TC increases as resistance increases. Metals and alloys typically have a positive TC. A negative value of TC indicates TC decreases as resistance increases.

The magnitude of the TC for the TFR may be significantly smaller (e.g., 1/100 or less) than the magnitude of the metal thermistor, so that the TFR may have little or no effect on the temperature data provided by the metal thermistor.

FIG. 11 depicts an example circuit 1100 including a remote temperature-sensing clement (RTSE) 1110 and an ADC front end 1150 of a sense circuit, where the RTSE includes a metal thermistor 1112 and a thin film resistor 1114, according to various embodiments. The circuit is consistent with FIGS. 6 and 7. A voltage Vtop is provided on a path 1103 by the ADC front end 1150 to the RTSE. A voltage Vbot is provided on a path 1105 by the ADC front end 1150 to the RTSE. A voltage Vout is provided on a path 1104 to the ADC front end 1150 from the RTSE. Vout is sampled by the ADC front end at the switches 1130 and 1135. The path 1104 is in series with and between the metal thermistor and the thin film resistor. The path 1104 is at a midpoint between the two resistors. The paths 1103, 1104 and 1105 have routing line resistances Rrout1, Rrout2 and Rrout3, respectively.

Vtop represents a voltage at a top or high side of the RTSE and Vbot represents a voltage at a bottom or low side of the RTSE, for example. These voltages may be about Vccin or 0 V depending on the switch settings. Vccin may be reduced by a loss associated with the routing resistances Rrout1 and Rrout3 before it reaches the RTSE. Similarly, Vout may be reduced by a loss associated with the routing resistance Rrout2 before it reaches the ADC front end.

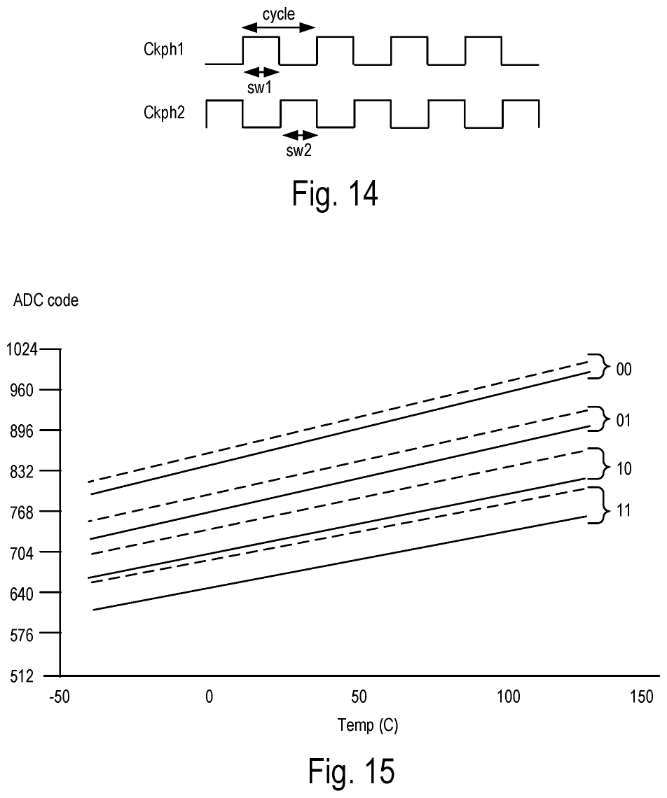

The ADC front end 1150 provides a local switching interface, and includes switches coupled to each of the three paths 1103, 1104 and 1105, where the switches are controlled by clock signals Ckph1 and Ckph2, which are alternately high and low. See also FIG. 14. For example, when a switch 1113 controlled by Ckph1 is closed (conductive), Vccin at a node 1111 is coupled to the path 1103, and when a switch 1115 controlled by Ckph2 is closed, the path 1103 is grounded to 0 V. When a switch 1120 controlled by Ckph2 is closed, Vccin at a node 1121 is coupled to the path 1105, and when a switch 1122 controlled by Ckph1 is closed, the path 1105 is grounded to 0 V. First, second and third pairs of switches are formed by the switches 1113 and 1115, 1120 and 1122 and 1130 and 1135, respectively.

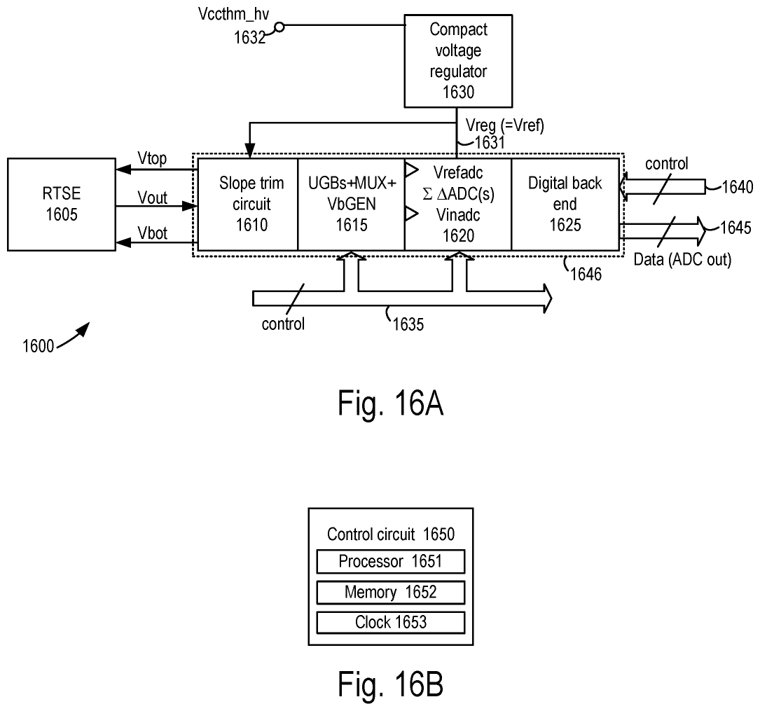

When a switch 1130 controlled by Ckph1 is closed, Vout on the path 1104 is provided/sampled as Vinadc (an input voltage to an ADC) at a node 1131. Vout also charges a capacitor, Cout1 to maintain the voltage at the node 1131 when the switch 1130 is opened (made non-conductive). When a switch 1135 controlled by Ckph2 is closed, Vout on the path 1104 is provided/sampled as Vrefadc (an input reference voltage to an ADC) at a node 1136. Vout also charges a capacitor, Cout2 to maintain the voltage at the node 1136 when the switch 1135 is opened. The voltages Vinadc and Vrefade can be provided to an ADC for further processing. See also FIG. 16A.

During the clock phase 1 (Ckph1), the left branch of the bridge of FIG. 5A is instantiated and Vout turns into Vin for the ADC. The left branch represents the input voltage reaching the TFR before the metal resistor. Conversely, during phase 2 (Ckph2), the right branch of the bridge is replicated and Vout becomes Vref for the ADC. The right branch represents the input voltage reaching the metal resistor before the TFR. Although there will be a measurable IR drop along the traces connecting Vtop and Vbot, as long as it is kept small compared to the Vout level, it can be represented as fluctuations in the Vccin of the original bridge, which can be cancelled out as explained earlier. This implementation allows for a smaller footprint since only one branch is implemented, and a lower trace count as Vout provides routing for both Vleft and Vright.

In an example implementation, a first pair of switches is coupled to one end of a remote temperature-sensing element, to alternately apply high and low voltages to the one end; a second pair of switches is coupled to another end of the remote temperature-sensing element, to alternately apply low and high voltages to the another end when the high and low voltages, respectively, are applied to the one end; and a third pair of switches coupled to a midpoint of the remote temperature-sensing element, to sample a voltage of the midpoint for use in an analog-to-digital circuit.

Additionally, the first pair of switches are to apply the high and low voltages in first and second clock phases, respectively; the second pair of switches are to apply the low and high voltages in the first and second clock phases, respectively; and the third pair of switches are to sample the voltage of the midpoint as an input voltage to the analog-to-digital circuit and as a reference voltage to the analog-to-digital circuit in the first and second clock phases, respectively.

As noted, the design is insensitive to Vccin. Specifically, since there is current flowing from the ADC front-end through the remote routes (Rout1 and Rout3), the effective Vccin that the RTSE receives (denoted as Vccin′) is lower and this would change from part to part when considering high volume manufacturing. However, since the readout is independent of what the Vccin′ level is, there is no performance trade-off when supporting remote sensing (within certain limits though—routing resistance should still be much lower than the total RTSE resistance in order to not impact overall sensitivity). For example, the arrow 1140 depicts a voltage Vccin-Vss′ (gnd′) between the paths 1103 and 1105, while the arrow 1141 depicts a voltage Vccin-Vss (gnd) between the paths 1103a and 1105a.

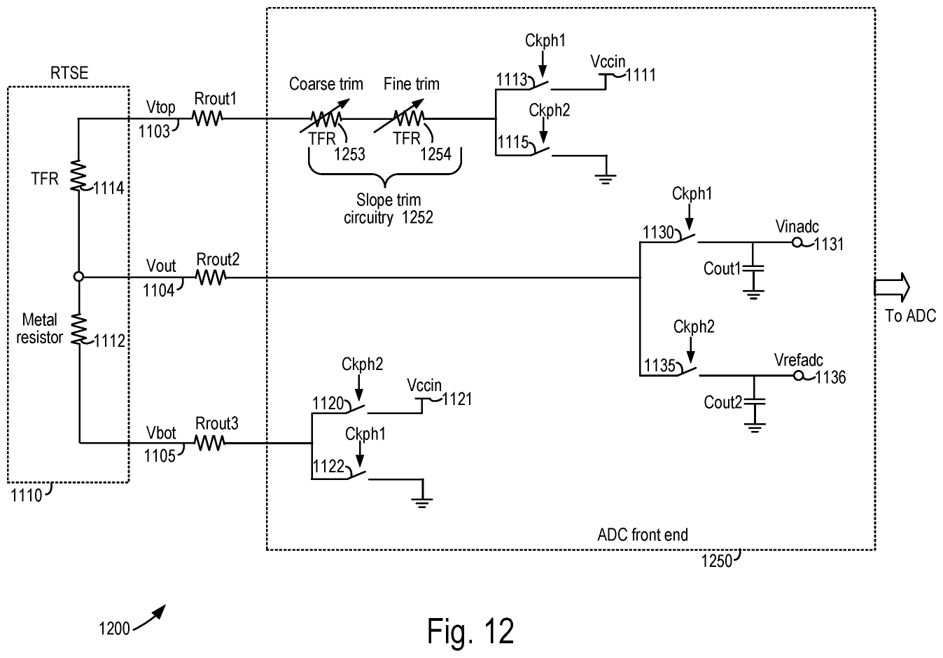

FIG. 12 depicts an example circuit 1200 including the remote temperature-sensing element (RTSE) 1110 of FIG. 11 and an ADC front end 1250 of a sense circuit, where the ADC front end includes built in slope trim circuitry 1252, according to various embodiments. The slope trim circuitry 1252 can include a coarse trim TFR 1253 and a fine trim TFR 1254 in series with the path 1103 and the switches 1113 and 1115.

D. Regarding the feature of slope trim support, as shown in the equation of FIG. 5F, the temperature-to-code slope is dependent on the ratio of the absolute value of the resistors, which are subject to process excursions, both intentional (e.g., due to a Process Design Kit update, etc.) or unplanned (e.g., across wafer variation changes due to layout effects, lithographic and etching variations that impact thickness of the metal trace, etc.). To limit the impact that such changes would have on the system's resolution (a shallow transfer function slope would reduce the system sensitivity), slope trim support circuitry has been included as shown in the ADC front end 1250.

The slope trim circuitry is local to the design core, as part of the ADC front end. The TFRs 1253 and 1254 are variable resistors which are used to adjust the value of the total TFR resistor composed by both the TFR 1114 of the remote element and the trim TFRs. Even though the trim TFRs are not at the same temperature as the TFR of the remote element, given the flat TC of the TFR, the offset introduced would be very small.

In this implementation, the slope trim circuitry comprises a first adjustable thin film resistor 1253 for coarse adjustments and a second adjustable thin film resistor 1254 for fine adjustments. Optionally, the slope trim circuitry comprises just one adjustable thin film resistor.

Additionally, while the slope trim circuitry is coupled between the path 1103 and the switches 1113 and 1115 in this example, it could alternatively be at the other side of the ADC front end 1250, coupled between the path 1105 and the switches 1120 and 1122.

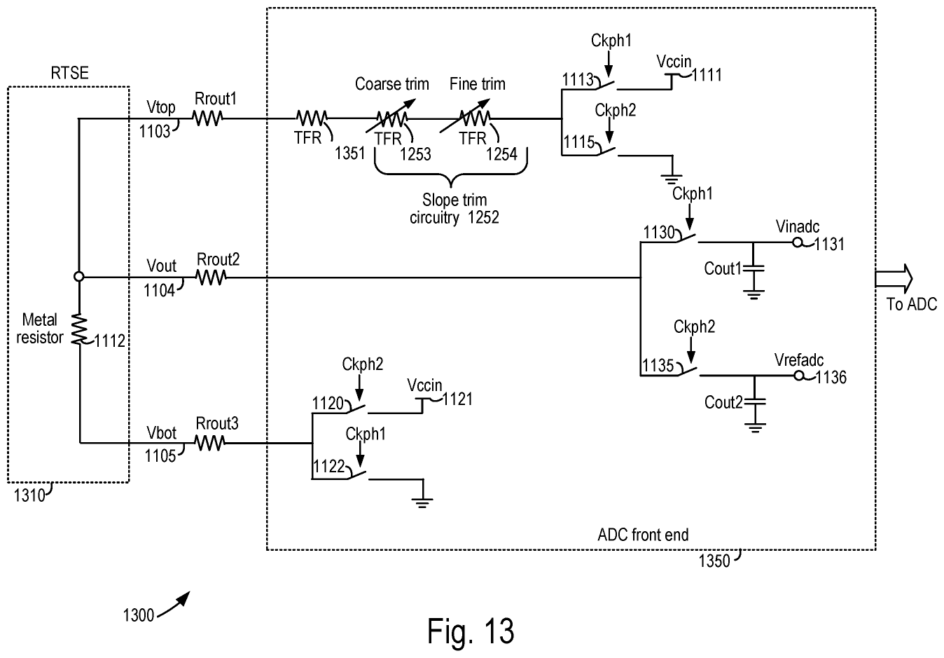

FIG. 13 depicts an example circuit 1300 including a remote temperature-sensing element (RTSE) 1310 and an ADC front end 1350 of a sense circuit, where the RTSE includes the metal thermistor 1112 of FIG. 11, and the ADC front end includes a non-variable thin film resistor 1351 and the built in slope trim circuitry 1252 of FIG. 12, according to various embodiments. In this implementation, the TFR is removed from the remote sensing element and combined locally with the trim TFRs as the TFR 1351. This approach advantageously reduces the remote element area. The feasibility of this option can be assessed as function of the expected variability of temperatures between the remote element location and the ADC front end location.

FIG. 14 depicts plots of the clock signals Ckph1 and Ckph2 in FIGS. 11-13, according to various embodiments. The clock signals can be anti-phase, e.g., have a 180 degree phase difference so that when one is high the other is low. The clock signals can be used to turn on the switches in the circuits of FIGS. 11-13 to obtain an output voltage from the RTSE which represents a temperature. The clocks may operate in consecutive switching cycles. An example switching cycle is depicted which includes first and second switching periods, sw1 and sw2, respectively.

FIG. 15 depicts plots of an ADC code versus temperature for different digital codes for a typical metal thermistor (solid lines) and for a fast (lower than typical resistance) metal thermistor (dashed lines), according to various embodiments. The plots show the effect of the fine trim on the transfer function slope for a typical Rmet (solid lines) and for a fast Rmet (dashed lines) with coarse settings at 01 and 10 respectively. The data is provided for code values of 00, 01, 10 and 11 and shows a relatively small difference between the two cases. The plots are based on simulation data that illustrates how the transfer function slope changes across both coarse and fine trim settings. The trim feature can be optionally provided depending on the actual measured variability of the transfer function slope from part-to-part in high-volume manufacturing.

FIG. 16A depicts an example system 1600 which uses a temperature sensor as described herein, according to various embodiments. This is one possible implementation of an overall system, and includes the remote temperature-sensing element 1605 and the voltages it inputs and outputs. A slope trim block 1610 may be provided to adjust the input voltages. A block 1615 represents unity gain buffers (UGBs), multiplexers (MUX) and VbGEN. VbGEN refers to a bias voltage generation circuit. In some cases, the unity gain buffers ((UGBs) may need a biasing circuit to ensure proper DC operating conditions for highest performance.

The block 1620 represents an analog-to-digital converter circuit which receives Vrefadc and Vinadc and produces an output code that is proportional to the ratio Vinadc/Vrefadc. The sigma symbol denotes a sigma-delta ADC. This type of ADC generates a serial output (a bit-stream where the density of 1's is proportional to the Vin/Vref ratio), where the function of the digital backend 1625 is to convert the serial data into a parallel bus (e.g., 9-bit if using a 512 oversampling rate, since 2\hat{ }9=512).

The digital backend 1625 receives a serial bit stream from the block 1620 and processes it into a 10-bit or 9-bit parallel output digital value which represents a temperature of the RTSE. The digital value may be output to a control circuit, such as the control circuit 1650 of FIG. 16B, for use in making decisions such as whether to throttle a processor if its temperature exceeds a threshold.

Arrows 1635 represent paths for control signals to be provided to the blocks 1615 and 1620. An arrow 1640 represents control signals receives by the digital back end and an arrow 1645 represents output data from the sense circuit 1646. A compact voltage regulator 1630 may be responsive to a voltage Vcchtm_hv such as 1.2 V at a node 1632 to provide an output voltage Vreg=Vref on a path 1631 to the blocks 1610 and 1620.

FIG. 16B depicts an example control circuit 1650 for use with the system 1600 of FIG. 16A, according to various embodiments. The control circuit includes a processor 1651, a memory device 1652 to store instructions to be executed by the processor, and a clock 1653 to provide the clock signals Ckph1 and Ckph2. The control circuit may communicate with the system 1600 such as to provide control signals and clock signals and to receive the ADC output data.

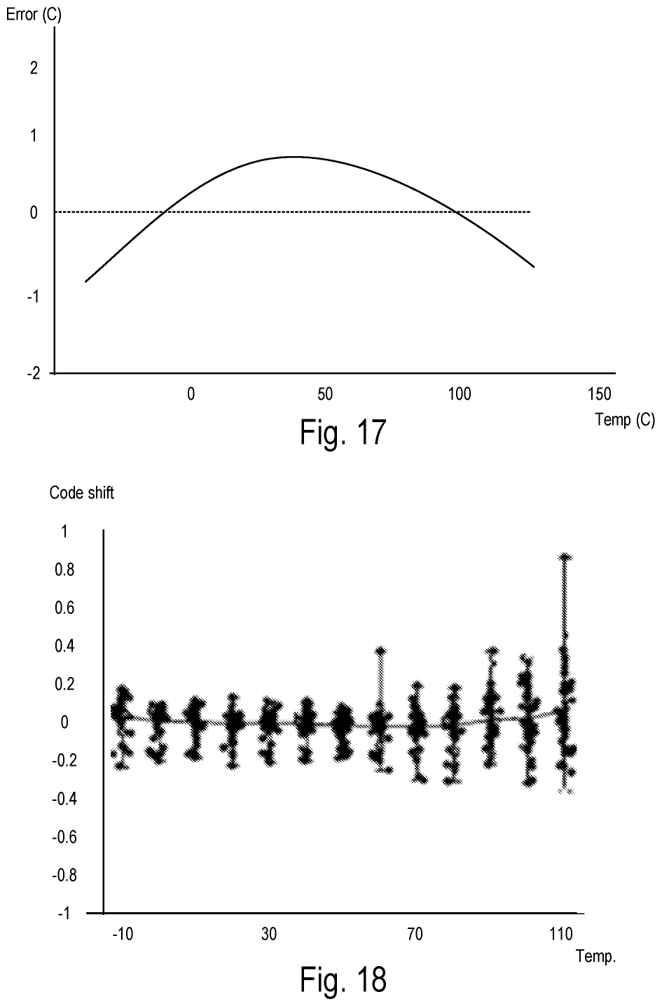

FIG. 17 depicts a plot of temperature error versus temperature for the system of FIG. 16A, according to various embodiments. The plot is based on a comparison of the calculated temperature error produced by the Vleft/Vright ratio in simulation with respect to data collected in an earlier test chip that only included a structure similar to that shown in FIG. 5A. The data shows a good correlation and a small error within current specifications.

FIG. 18 depicts a plot of a measured equivalent code shift versus temperature for the system of FIG. 16A, at different temperatures, according to various embodiments. This shows a measured shift as a function of the reference voltage (Vccin), and confirms the insensitivity of the design to this metric. The measured equivalent “code” shift or delta is between Vccin levels at 1.0 V and 0.9 V.

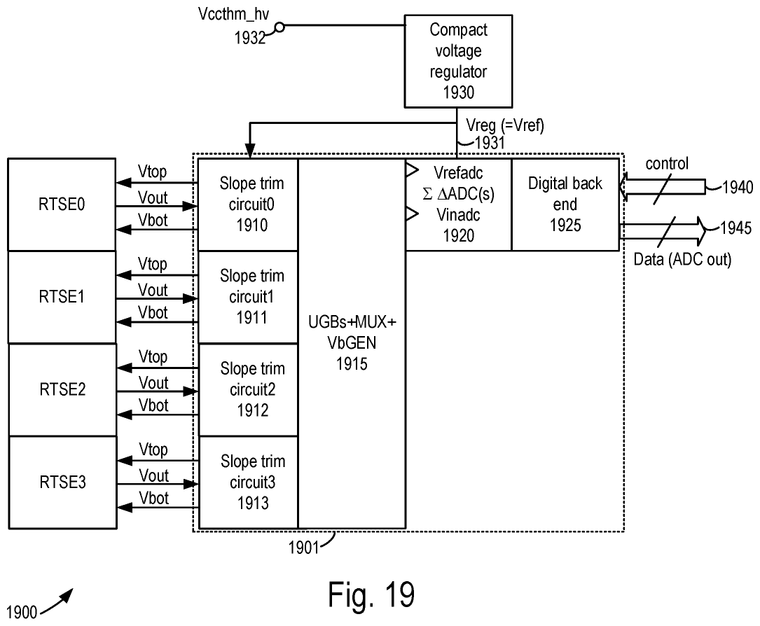

FIG. 19 depicts an example circuit 1900 including multiple remote temperature-sensing element (RTSEs) and a sense circuit 1901, according to various embodiments. In this option, a single sense circuit 1901 can support multiple RTSEs, e.g., RTSE0-RTSE3. The sense circuit includes a multiplexer 1915 that allows the routing of the Vout of multiple RTSEs to the ADCs (as separate valueso f Vrefadc and Vinadc). While four RTSEs are depicted, the number could be larger, e.g., 8 or 16 RTSEs, or smaller. Additional control circuitry can be used to perform a round robin conversion so that, starting from RTSE0, the other RTSEs are measured in sequence and then the process repeats itself.

The sense circuit include a dedicated slope trim circuit 1910, 1911, 1912 and 1913 for each RTSE, RTSE0, RTSE1, RTSE2 and RTSE3, respectively. Alternatively, there is no need to have a dedicated slope trim circuit for each RTSE if the systematic variation of the median resistor values does not change significantly per die, in which case a single trim value can be used by all RTSEs. However, the routing resistance (Rout1 and Rout3) may be different across RTSEs instances but due to the Vccin insensitivity discussed above, there is no performance trade-off.

The block 1920 is similar to the 1620 and represents an analog-to-digital converter circuit. The block 1925 is similar to the digital back end 1625. An arrow 1940 represents control signals receives by the digital back end and an arrow 1945 represents output data from the sense circuit 1901. A compact voltage regulator 1930 may be responsive to a voltage Vcchtm_hv such as 1.2 V at a node 1932 to provide an output voltage Vreg=Vref on a path 1931 to the blocks 1910-1913 and 1920.

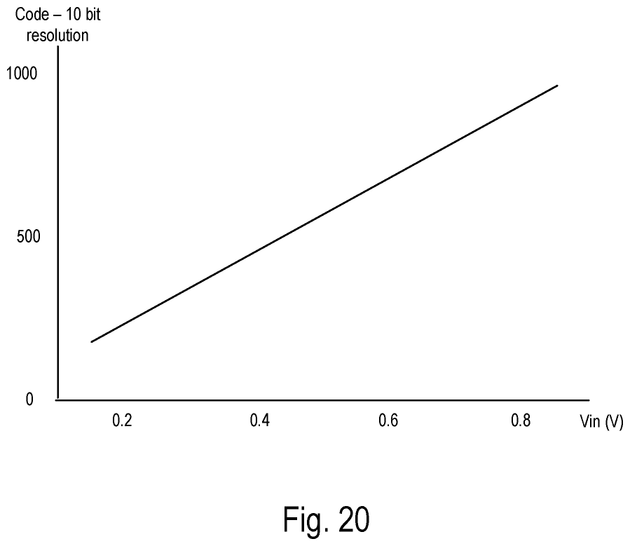

FIG. 20 depicts an example plot showing a correspondence between an input voltage, Vin, and a digital code in an analog-to-digital converter (ADC), according to various embodiments. The ADC performs with a ratio of Vin to Vref (or Vleft/Vright).

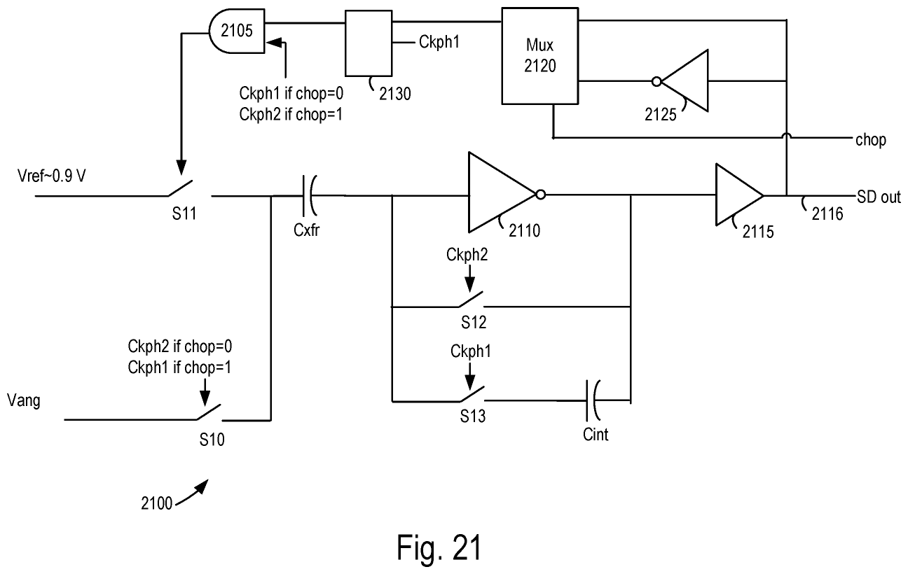

FIG. 21 depicts an example ADC circuit 2100, according to various embodiments. The ADC has a transfer function of code=(Vbe/Vref)×OSR, where OSR is the oversampling rate. Vbe=Vang−Vin. The OSR is set to 512, which gives a DTS resolution of ˜1 C. The circuit receives Vref and Vang as voltage inputs. An output of an AND gate 2105 controls a switch S11 to block or pass Vref to a transfer capacitor Cxft, while switch S10 blocks or passes Vang to Cxft. S10 is controlled by Ckph2 if chop=0 and Ckph1 if chop=1. Chop is a signal input to a mux 2120. Cxft is coupled to an amplifier 2110, a switch S12, and a switch S13 and capacitor Cint, in three parallel paths. S12 and S13 are controlled by Ckph2 and Ckph1, respectively. The output of the three parallel paths is provided to a buffer 2115 having an output, which in turn is coupled to an output node 2116 at SDout.

The mux 2120 receives inputs including the chop signal, an output of an inverter 2125 and SDout from the output node 2116. SDOut is the digital output of the ADC. The output of the mux is provided to a flip-flop 2130 having an output coupled to the AND gate 2105. An additional input to the AND gate is Ckph1 if chop=0 and Ckph2 if chop=1.

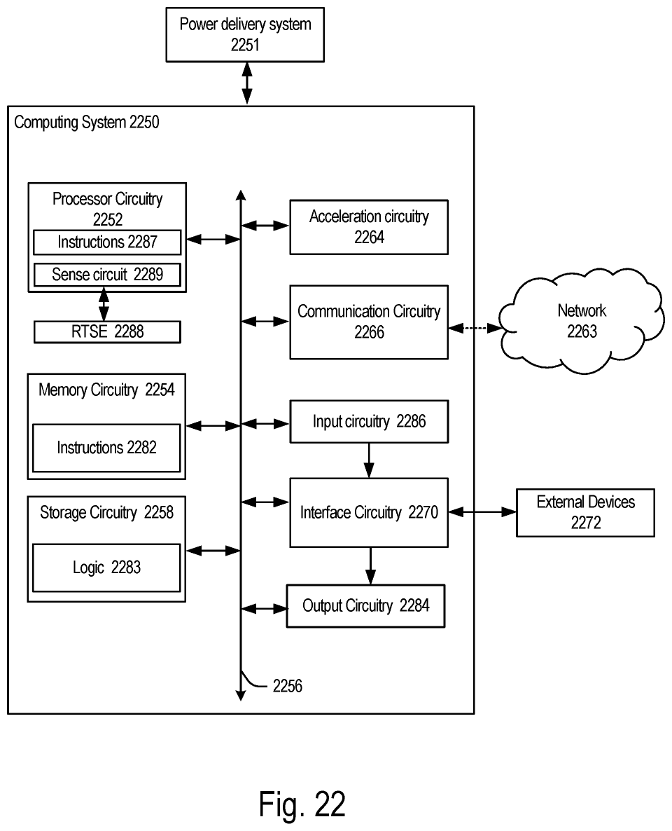

FIG. 22 illustrates an example of components that may be present in a computing system 2250 for implementing the techniques (e.g., operations, processes, methods, and methodologies) described herein, according to various embodiments.

The processor circuitry 2252 may include a sense circuit 2289 which represents one of the sense circuits 1646 or 1901 or the ADC front ends 1150, 1250 or 1350 discussed previously, for example. Additionally, the RTSE 2288 may represent one of the RTSEs 215, 315, 415, 1110, 1310 or RTSE0-RTSE3 discussed previously, for example.

The computing system 2250 may be powered by a power delivery subsystem 2251 and include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 2250, or as components otherwise incorporated within a chassis of a larger system. For one embodiment, at least one processor 2252 may be packaged together with computational logic 2282 and configured to practice aspects of various example embodiments described herein to form a System in Package (SiP) or a System on Chip (SoC).

The system 2250 includes processor circuitry in the form of one or more processors 2252. The processor circuitry 2252 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 2252 may include one or more hardware accelerators (e.g., same or similar to acceleration circuitry 2264), which may be microprocessors, programmable processing devices (e.g., FPGA, ASIC, etc.), or the like. The one or more accelerators may include, for example, computer vision and/or deep learning accelerators. In some implementations, the processor circuitry 2252 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor circuitry 2252 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low voltage processor, an embedded processor, or any other known processing elements, or any suitable combination thereof. The processors (or cores) 2252 may be coupled with or may include memory/storage and may be configured to execute instructions stored in the memory/storage to enable various applications or operating systems to run on the platform 2250. The processors (or cores) 2252 is configured to operate application software to provide a specific service to a user of the platform 2250. In some embodiments, the processor(s) 2252 may be a special-purpose processor(s)/controller(s) configured (or configurable) to operate according to the various embodiments herein.

As examples, the processor(s) 2252 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 2252 may be a part of a system on a chip (SoC), System-in-Package (SiP), a multi-chip package (MCP), and/or the like, in which the processor(s) 2252 and other components are formed into a single integrated circuit, or a single package, such as the Edison™ or Galileo™ SoC boards from Intel® Corporation. Other examples of the processor(s) 2252 are mentioned elsewhere in the present disclosure.

The system 2250 may include or be coupled to acceleration circuitry 2264, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 2264 may comprise logic blocks or logic fabric and other interconnected resources that may be programmed (configured) to perform various functions, such as the procedures, methods, functions, etc. of the various embodiments discussed herein. In such implementations, the acceleration circuitry 2264 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 2252 and/or acceleration circuitry 2264 may include hardware elements specifically tailored for machine learning and/or artificial intelligence (AI) functionality. In these implementations, the processor circuitry 2252 and/or acceleration circuitry 2264 may be, or may include, an AI engine chip that can run many different kinds of AI instruction sets once loaded with the appropriate weightings and training code. Additionally or alternatively, the processor circuitry 2252 and/or acceleration circuitry 2264 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPs™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 2252 and/or acceleration circuitry 2264 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 970 provided by Huawei®, and/or the like. In some hardware-based implementations, individual subsystems of system 2250 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 2250 also includes system memory 2254. Any number of memory devices may be used to provide for a given amount of system memory. As examples, the memory 2254 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 2254 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 2254 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 2258 provides persistent storage of information such as data, applications, operating systems and so forth. In an example, the storage 2258 may be implemented via a solid-state disk drive (SSDD) and/or high-speed electrically erasable memory (commonly referred to as “flash memory”). Other devices that may be used for the storage 2258 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 2254 and/or storage circuitry 2258 may also incorporate three-dimensional (3D) cross-point (XPOINT) memories from Intel® and Micron®.

The memory circuitry 2254 and/or storage circuitry 2258 is/are configured to store computational logic 2283 in the form of software, firmware, microcode, or hardware-level instructions to implement the techniques described herein. The computational logic 2283 may be employed to store working copies and/or permanent copies of programming instructions, or data to create the programming instructions, for the operation of various components of system 2250 (e.g., drivers, libraries, application programming interfaces (APIs), etc.), an operating system of system 2250, one or more applications, and/or for carrying out the embodiments discussed herein. The computational logic 2283 may be stored or loaded into memory circuitry 2254 as instructions 2282, or data to create the instructions 2282, which are then accessed for execution by the processor circuitry 2252 to carry out the functions described herein. The processor circuitry 2252 and/or the acceleration circuitry 2264 accesses the memory circuitry 2254 and/or the storage circuitry 2258 over the interconnect (IX) 2256. The instructions 2282 direct the processor circuitry 2252 to perform a specific sequence or flow of actions, for example, as described with respect to flowchart(s) and block diagram(s) of operations and functionality depicted previously. The various elements may be implemented by assembler instructions supported by processor circuitry 2252 or high-level languages that may be compiled into instructions 2287, or data to create the instructions 2287, to be executed by the processor circuitry 2252. The permanent copy of the programming instructions may be placed into persistent storage devices of storage circuitry 2258 in the factory or in the field through, for example, a distribution medium (not shown), through a communication interface (e.g., from a distribution server (not shown)), over-the-air (OTA), or any combination thereof.

The IX 2256 couples the processor 2252 to communication circuitry 2266 for communications with other devices, such as a remote server (not shown) and the like. The communication circuitry 2266 is a hardware element, or collection of hardware elements, used to communicate over one or more networks 2263 and/or with other devices. In one example, communication circuitry 2266 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 2266 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 2256 also couples the processor 2252 to interface circuitry 2270 that is used to connect system 2250 with one or more external devices 2272. The external devices 2272 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 2250, which are referred to as input circuitry 2286 and output circuitry 2284. The input circuitry 2286 and output circuitry 2284 include one or more user interfaces designed to enable user interaction with the platform 2250 and/or peripheral component interfaces designed to enable peripheral component interaction with the platform 2250. Input circuitry 2286 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 2284 may be included to show information or otherwise convey information, such as sensor readings, actuator position(s), or other like information. Data and/or graphics may be displayed on one or more user interface components of the output circuitry 2284. Output circuitry 2284 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 2250. The output circuitry 2284 may also include speakers and/or other audio emitting devices, printer(s), and/or the like. Additionally or alternatively, sensor(s) may be used as the input circuitry 2284 (e.g., an image capture device, motion capture device, or the like) and one or more actuators may be used as the output device circuitry 2284 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 2250 may communicate over the IX 2256. The IX 2256 may include any number of technologies, including ISA, extended ISA, I2C, SPI, point-to-point interfaces, power management bus (PMBus), PCI, PCle, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 2256 may be a proprietary bus, for example, used in a SoC based system.

The number, capability, and/or capacity of the elements of system 2250 may vary, depending on whether computing system 2250 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 2250 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible, non-transitory machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.

Example 1 includes an apparatus, comprising: a substrate; a stack on the substrate, the stack comprising a plurality of metal layers separated from one another by dielectric layers; a metal thermistor in a selected metal layer of the plurality of metal layers; a thin film resistor in series with the metal thermistor; and a sense circuit remote from the metal thermistor, wherein the sense circuit is coupled to the metal thermistor and is to obtain temperature data from the metal thermistor.

Example 2 includes the apparatus of Example 1, wherein the metal thermistor is serpentine or spiral shaped.

Example 3 includes the apparatus of Example 1 or 2, wherein the thin film resistor is in a selected dielectric layer of the dielectric layers, and the selected dielectric layer is adjacent to the selected metal layer.

Example 4 includes the apparatus of Example 3, wherein the metal thermistor overlaps with the thin film resistor in the stack.

Example 5 includes the apparatus of any one of Examples 1-4, wherein the thin film resistor is in the sense circuit.

Example 6 includes the apparatus of any one of Examples 1-5, wherein to obtain the temperature data from the metal thermistor, the sense circuit is to alternately apply voltages to one end of the metal thermistor and to one end of the thin film resistor, and to sample an output voltage from the metal thermistor from a point which is in series with and between the metal thermistor and the thin film resistor.

Example 7 includes the apparatus of Example 6, wherein the sense circuit is to alternately provide the sampled output voltage to an analog-to-digital converter as an input voltage and as a reference voltage.

Example 8 includes the apparatus of any one of Examples 1-7, wherein the sense circuit comprises slope trim circuitry to adjust a temperature-to-code slope.

Example 9 includes the apparatus of Example 8, wherein the slope trim circuitry comprises one or more adjustable thin film resistors.

Example 10 includes the apparatus of Example 8 or 9, wherein the slope trim circuitry comprises a first adjustable thin film resistor for a coarse adjustment and a second adjustable thin film resistor for a fine adjustment.

Example 11 includes an apparatus, comprising: a substrate; a stack on the substrate, the stack comprising a plurality of metal layers separated from one another by dielectric layers; and a remote temperature-sensing element in the stack.

Example 12 includes the apparatus of Example 11, wherein the remote temperature-sensing element comprises a metal thermistor in a selected metal layer of the plurality of metal layers.

Example 13 includes the apparatus of Example 12, wherein: the remote temperature-sensing element comprises a thin film resistor in a selected dielectric layer of the dielectric layers; the thin film resistor is in series with the metal thermistor; and the selected dielectric layer is adjacent to the selected metal layer.

Example 14 includes the apparatus of Example 13, wherein a remote sense circuit is coupled to one end of the metal thermistor, one end of the thin film resistor, and a point which is in series with and between the metal thermistor and the thin film resistor.

Example 15 includes the apparatus of Example 13 or 14, wherein the thin film resistor comprises a metal alloy.

Example 16 includes the apparatus of any one of Examples 11-15, wherein the stack is on a front side of the substrate, adjacent to a transistor layer in the substrate, and the remote temperature-sensing element is directly above a location in the transistor layer having a temperature of interest.

Example 17 includes the apparatus of any one of Examples 11-16, wherein: the substrate is a front side substrate comprising a transistor layer; the apparatus further comprises a backside substrate attached to the front side substrate; the stack is on the backside substrate; and the remote temperature-sensing element is directly below a location in the transistor layer having a temperature of interest.

Example 18 includes a circuit, comprising: a first pair of switches coupled to one end of a remote temperature-sensing element, to alternately apply high and low voltages to the one end; a second pair of switches coupled to another end of the remote temperature-sensing element, to alternately apply low and high voltages to the another end when the high and low voltages, respectively, are applied to the one end; and a third pair of switches coupled to a midpoint of the remote temperature-sensing element, to sample a voltage of the midpoint for use in an analog-to-digital circuit.

Example 19 includes the circuit of Example 18, wherein: the first pair of switches are to apply the high and low voltages in first and second switching periods, respectively; the second pair of switches are to apply the low and high voltages in the first and second switching periods, respectively; and the third pair of switches are to sample the voltage of the midpoint as an input voltage to the analog-to-digital circuit and as a reference voltage to the analog-to-digital circuit in the first and second switching periods, respectively.

Example 20 includes the circuit of Example 19, further comprising a thin film resistor coupled to the first pair of switches and the remote temperature-sensing element.

Example 21 includes a method, comprising: obtaining temperature data from a metal thermistor at a circuit, wherein the circuit is remote from the metal thermistor, the metal thermistor in a selected metal layer of the plurality of metal layers on a stack, and a thin film resistor is in series with the metal thermistor.

Example 22 includes the method of Example 21, further comprising: to obtain the temperature data from the metal thermistor, alternately applying voltages to one end of the metal thermistor and to one end of the thin film resistor; and sampling an output voltage from the metal thermistor from a point which is in series with and between the metal thermistor and the thin film resistor.

Example 23 includes the method of Example 22, further comprising alternately providing the sampled output voltage to an analog-to-digital converter as an input voltage and as a reference voltage.

Example 24 includes a non-transitory machine-readable storage including machine-readable instructions that, when executed, cause a processor or other circuit or computing device to implement the method of any one of Examples 21 to 23.

Example 25 includes a computer program comprising instructions which, when the program is executed by a computer, cause the computer to carry out the method of any one of Examples 21 to 23.

Example 26 includes a method, comprising: at a first pair of switches coupled to one end of a remote temperature-sensing element, alternately applying high and low voltages to the one end; at a second pair of switches coupled to another end of the remote temperature-sensing element, alternately apply low and high voltages to the another end when the high and low voltages, respectively, are applied to the one end; and at a third pair of switches coupled to a midpoint of the remote temperature-sensing element, sampling a voltage of the midpoint for use in an analog-to-digital circuit.

Example 27 includes the method of Example 26, further comprising: at the first pair of switches, applying the high and low voltages in first and second switching periods, respectively; at the second pair of switches, applying the low and high voltages in the first and second switching periods, respectively; and at the third pair of switches, sampling the voltage of the midpoint as an input voltage to the analog-to-digital circuit and as a reference voltage to the analog-to-digital circuit in the first and second switching periods, respectively.

Example 28 includes a non-transitory machine-readable storage including machine-readable instructions that, when executed, cause a processor or other circuit or computing device to implement the method of any one of Examples 26 to 27.

Example 29 includes a computer program comprising instructions which, when the program is executed by a computer, cause the computer to carry out the method of any one of Examples 26 to 27.

In the present detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
a substrate;
a stack on the substrate, the stack comprising a plurality of metal layers separated from one another by dielectric layers;
a metal thermistor in a selected metal layer of the plurality of metal layers;
a thin film resistor in series with the metal thermistor; and
a sense circuit remote from the metal thermistor, wherein the sense circuit is coupled to the metal thermistor and is to obtain temperature data from the metal thermistor.

2. The apparatus of claim 1, wherein the metal thermistor is serpentine or spiral shaped.

3. The apparatus of claim 1, wherein the thin film resistor is in a selected dielectric layer of the dielectric layers, and the selected dielectric layer is adjacent to the selected metal layer.

4. The apparatus of claim 3, wherein the metal thermistor overlaps with the thin film resistor in the stack.

5. The apparatus of claim 1, wherein the thin film resistor is in the sense circuit.

6. The apparatus of claim 1, wherein to obtain the temperature data from the metal thermistor, the sense circuit is to alternately apply voltages to one end of the metal thermistor and to one end of the thin film resistor, and to sample an output voltage from the metal thermistor from a point which is in series with and between the metal thermistor and the thin film resistor.

7. The apparatus of claim 6, wherein the sense circuit is to alternately provide the sampled output voltage to an analog-to-digital converter as an input voltage and as a reference voltage.

8. The apparatus of claim 1, wherein the sense circuit comprises slope trim circuitry to adjust a temperature-to-code slope.

9. The apparatus of claim 8, wherein the slope trim circuitry comprises one or more adjustable thin film resistors.

10. The apparatus of claim 8, wherein the slope trim circuitry comprises a first adjustable thin film resistor for a coarse adjustment and a second adjustable thin film resistor for a fine adjustment.

11. An apparatus, comprising:
a substrate;
a stack on the substrate, the stack comprising a plurality of metal layers separated from one another by dielectric layers; and
a remote temperature-sensing element in the stack.

12. The apparatus of claim 11, wherein the remote temperature-sensing element comprises a metal thermistor in a selected metal layer of the plurality of metal layers.

13. The apparatus of claim 12, wherein:
the remote temperature-sensing element comprises a thin film resistor in a selected dielectric layer of the dielectric layers;
the thin film resistor is in series with the metal thermistor; and
the selected dielectric layer is adjacent to the selected metal layer.

14. The apparatus of claim 13, wherein a remote sense circuit is coupled to one end of the metal thermistor, one end of the thin film resistor, and a point which is in series with and between the metal thermistor and the thin film resistor.

15. The apparatus of claim 13, wherein the thin film resistor comprises a metal alloy.

16. The apparatus of claim 11, wherein the stack is on a front side of the substrate, adjacent to a transistor layer in the substrate, and the remote temperature-sensing element is directly above a location in the transistor layer having a temperature of interest.

17. The apparatus of claim 11, wherein:
the substrate is a front side substrate comprising a transistor layer;
the apparatus further comprises a backside substrate attached to the front side substrate;
the stack is on the backside substrate; and
the remote temperature-sensing element is directly below a location in the transistor layer having a temperature of interest.

18. A circuit, comprising:
a first pair of switches coupled to one end of a remote temperature-sensing element, to alternately apply high and low voltages to the one end;
a second pair of switches coupled to another end of the remote temperature-sensing element, to alternately apply low and high voltages to the another end when the high and low voltages, respectively, are applied to the one end; and
a third pair of switches coupled to a midpoint of the remote temperature-sensing element, to sample a voltage of the midpoint for use in an analog-to-digital circuit.

19. The circuit of claim 18, wherein:
the first pair of switches are to apply the high and low voltages in first and second switching periods, respectively;
the second pair of switches are to apply the low and high voltages in the first and second switching periods, respectively; and
the third pair of switches are to sample the voltage of the midpoint as an input voltage to the analog-to-digital circuit and as a reference voltage to the analog-to-digital circuit in the first and second switching periods, respectively.

20. The circuit of claim 19, further comprising a thin film resistor coupled to the first pair of switches and the remote temperature-sensing element.
